(19) United States
(12) Patent Application Publication
(10) Pub. No.: US 2023/0298002 A1
(43) Pub. Date: Sep. 21, 2023

(54) DIGITAL WALLET TRACING ENGINE

(71) Applicant: Bank of America Corporation, Charlotte, NC (US)

(72) Inventors: Samuel M. Moiyallah, JR., Newark, DE (US); Julio Alessandro Vancini, McKinney, TX (US); Susan J. Moss, Vestal, NY (US); Joseph B. Castinado, Northglenn, CO (US); Samhitha Devarapally, Charlotte, NC (US)

(21) Appl. No.: 17/699,306

(22) Filed: Mar. 21, 2022

(51) Int. Cl. G06Q 20/36; G06Q 20/38

(52) U.S. Cl. CPC G06Q 20/36; G06Q 20/3829; G06Q 20/389

(57) ABSTRACT

A conversion engine is provided that bridges gaps between various emerging payment technologies and their respective proprietary ecosystems. The conversion engine may be configured to forward currency received from an ecosystem to an account/digital wallet external to the ecosystem. The conversion engine may accept a fraud alert that triggers tracing of digital wallets that have received any sub-amount of funds transferred by the conversion engine. The conversion engine may flag any digital wallet that includes a sub-amount, prevent any further transfer of the sub-amount and a reverse a transfer of the sub-amount.

### FIELD OF TECHNOLOGY

This application describes apparatus and methods for digital wallet technology.

### BACKGROUND

As the world progresses towards a cashless payment society, there has been a rise in the various forms of emerging payment technologies. Such technologies may include digital wallet payment systems. A digital wallet payment system may include hardware and software that securely stores customer’s payment information and passwords for storing, sending and receiving digital currency. A digital wallet system may also provide secure storage for electronic tickets and documents.

Many different digital wallet payment systems are now available in the marketplace. However, each digital wallet payment system typically uses its own proprietary technology, communication protocols, data structures and encryption.

Additionally, there are currently no available tools to track movement of currency among digital wallet payment systems. Customers that erroneously send currency may not be able to recover those funds. In today’s digital world, sophisticated schemes may mislead customer’s to believe that they are donating currency to reputable cause. For example, unscrupulous actors may mislead customers into thinking they are making a genuine charitable donation or financially assisting a relative in a foreign country.

After the customer electronically sends currency in response to the fraudulent request, there currently are no tools available to track and attempt to recover the erroneously transmitted currency. Such erroneously transmitted currency is typically lost and is the personal responsibility of the customer. Often, scammers prey on vulnerable customers such as the elderly or those without a good command of a local language. These vulnerable customers are generally poorly situated to bear any ensuing financial loss.

There is a need for hardware and software tools that bridge the gap among different digital wallet payment systems and their respective proprietary ecosystems. There is also a need for hardware and software tools that track transferred currency as the currency moves among the proprietary ecosystems. It would also be desirable to provide hardware and software tools that allow for recovery of erroneously transferred currency. Accordingly, it is desirable to provide apparatus and methods for a DIGITAL WALLET TRACING ENGINE.

### BRIEF DESCRIPTION OF THE DRAWINGS

The objects and advantages of the disclosure will be apparent upon consideration of the following detailed description, taken in conjunction with the accompanying drawings, in which like reference characters refer to like parts throughout, and in which:

FIG. 1 shows an illustrative system in accordance with principles of the disclosure;

FIG. 2 shows an illustrative system in accordance with principles of the disclosure;

FIG. 3 shows an illustrative process in accordance with principles of the disclosure;

FIG. 4 shows an illustrative process in accordance with principles of the disclosure;

FIGS. 5A and 5B show illustrative information in accordance with principles of the disclosure; and

FIG. 6 shows illustrative system and process in accordance with principles of the disclosure.

### DETAILED DESCRIPTION

Apparatus for bridging between multiple digital wallet systems is provided. Apparatus may include one or more computers that can be configured to perform particular operations or actions by virtue of having software, firmware, hardware, or a combination of thereof installed on the system that in operation causes or cause the system to perform functionality of the digital wallet system. Apparatus may include a conversion engine that traces currency as the currency moves among multiple incompatible digital wallet systems. The conversion engine may include computer programs recorded on one or more computer storage devices, each configured to perform functionality of the conversion engine.

The conversion engine may include machine executable instructions running on a computing system. The executable instructions may be self-executing and trigger actions at specified times and/or based on reference to the occurrence or non-occurrence of a target action or event. Some or all of the computer executable instructions may be embodied in hardware or firmware components of a computing system.

For example, the conversion engine may include one or more smart contracts. A smart contract may include machine executable instructions running on a computing system. The executable instructions may be self-executing and trigger actions at specified times and/or based on reference to the occurrence or non-occurrence of a target action or event. Some or all of the computer executable instructions may be embodied in hardware or firmware components of a computing system.

Smart contract may execute in a cloud computing environment that includes virtual software implementations. Such virtual software implementations may be designed to run on physical hardware supplied externally by a hosting provider, a client, or other platform. The conversion engine and associated smart contracts may include computer executable instructions for invoking user functionality related to communication, such as email, short message service (“SMS”), and voice input and speech recognition applications.

The conversion engine and associated smart contracts may utilize computer-executable instructions, such as program modules, executed by a processor on the computing system. Generally, program modules include routines, programs, objects, components, data structures, etc. that perform particular tasks or implement particular abstract data types. The conversion engine and associated smart contracts may be operational with distributed computing environments where tasks are performed by remote processing devices that are linked through a communications network. In a distributed computing environment, program modules may be located in both local and remote computer storage media including memory storage devices. The conversion engine and associated smart contracts may rely on a network of remote servers hosted on the Internet to store, manage, and process data (e.g., “cloud computing” and/or “fog computing”).

Smart contracts may be run on nodes that form a distributed ledger. A distributed ledger system may include a decentralized and tamperproof database. A distributed ledger system may include protocols that allows records to be verified by unreliable nodes. An exemplary distributed ledger may include a blockchain. Records stored in a blockchain are organized in blocks. Each block may include multiple records. The blocks are linked to one another and secured using cryptography.

Records stored in a distributed electronic ledger system may only be added to the system when the nodes responsible for maintaining data stored by the system reach agreement in accordance with a consensus mechanism in effect for the system. A key component of a consensus mechanism is proof of work.

Each node that wises to store new records in the distributed ledger must successfully solve a computationally intensive task before being authorized to add the new records. The proof of work is typically complex to solve and at the same time easily verifiable by other nodes once completed. This dichotomy ensures that only one node is authorized to add new records and that all other nodes can easily verify that the new records have been properly linked to prior records. The computationally intensive nature of the block generation process provides tamperproof and auditable storage of records.

It is computationally expensive for a malicious attacker to modify records and attempt to corrupt their contents. The rest of the trusted nodes on the network would continuously generate new records, outrunning the attacker in the process of adding new records to the distributed ledger system. Therefore, a trusted branch of blocks or other repository of records will grow faster than any new records generated by the attacker. Nodes participating the distributed ledger system are programmed to recognize the largest record repository on the network as the authoritative source of information. The nodes will therefore invalidate any smaller repositories created by the attacker.

In order for a manipulated record to be successfully added to the distributed ledger system, it would be necessary for the malicious attacker to solve the proof of work faster than the rest of nodes on distributed ledger system. On a distributed ledger system, this is structured to be computationally too expensive for the attacker. Accomplishing this feat requires having control of at least 51% of the computing resources in the distributed ledger system. The distributed ledger system may use any suitable consensus mechanism such as Proof of Work, Proof of Stake or Practical Byzantine Fault Tolerance.

The distributed ledger may be a public or non-permissioned distributed ledger. A public distributed ledger does not have restrictions on nodes that may participate in the process of establishing a consensus for adding a new record. The distributed ledger may be a private or permissioned distributed ledger. A private distributed ledger may include restrictions on who may participate in the establishing a consensus for adding a new record.

A distributed ledger may utilize a combination of private and public participation to establish a consensus. For example, the distributed ledger may require a threshold number of private and/or public “approvals” before recording a transaction on the distributed ledger. For example, records may only be added to the distributed ledger when nodes that rely on the distributed ledger (e.g., digital wallet system or systems responsible for maintaining the source or destination accounts) reach a consensus. Utilization of private entities may allow for achieving a consensus (or rejection) of a transaction faster than wholly public distributed ledgers.

Digital wallet systems are typically configured to interaction with a distributed ledger. The customer of a digital wallet system may run software and/or hardware (collectively, a “digital wallet”) that is compatible with a particular digital wallet system and its associated distributed ledger. A digital wallet may include electronic devices and programs used for making payments or purchases digitally, without presenting a physical credit card, debit card, or cash. A digital wallet may include an electronic device (e.g., smartphone) that stores payment information and the computer program (e.g., application) used to make the payment. A digital wallet may also hold other information, such as identity credentials, transportation tickets, event tickets, loyalty or gift credentials.

Typically, a customer operating a digital wallet compatible with one digital wallet system is unable to transfer or receive currency from a user operating a digital wallet compatible with another digital wallet system. Currency may include conventional currencies (e.g., USD, EUR, AUD, GBP, JPY, CAD). Currency may include cryptocurrencies (e.g., Bitcoin, Ethereum, Ripple, Bitcoin Cash, NEM, Litecoin, IOTA, NEO, Dash, Qtum, Monero and/or Dogecoin). A digital wallet system may apply proprietary security requirements and formulate proprietary communications that are not understood by other digital wallet systems and digital wallets associated with those other digital wallet systems.

The conversion engine may provide a bridge that solves technological communication gaps due to incompatibility of digital wallet systems. The conversion engine may receive a request from a source digital wallet. The conversion engine may extract a first destination digital wallet from the request. The request may be received formulated using the source digital wallet. The request may be formulated by the source digital wallet using data structures, encryption or communication protocols that are incompatible with the first destination digital wallet and the associated destination digital wallet system.

The conversion engine may extract an amount from the request. The amount may be a value of a desired currency transfer. Based on the amount and the first destination digital wallet, the conversion engine may divide the amount into a plurality of sub-amounts. Each sub-amount may represent a value of currency that will be tracked by the conversion engine. For example, after currency is transferred to a destination digital wallet, different amounts of the currency may be transferred to other digital wallets. The subsequent transfers may include adding additional currency to the currency received from the source digital wallet. The subsequent transfers may include subdividing the currency into sub-amounts.

Each of the subsequent currency transfers initiated by the recipient may be legitimate. The recipient of the currency may make a multiple small purchases using the currency received from the source digital wallet. However, each of the subsequent transfers initiated by the recipient may also be attempts to obscure an illegitimate motivation of the recipient. For example, the recipient may attempt to transfer multiple small amounts of the received currency to make it difficult to track an ultimate destination of the currency or illegitimate use of the currency.

The conversion engine may assign a unique identifier to each sub-amount. The conversion engine may package each sub-amount within a specialized data structure. The specialized data structure may prevent each sub-amount from being subdivided into any smaller amounts. If the recipient were allowed to divide the received currency into amounts smaller than the sub-amount, tracking subsequent transfers from the first destination digital wallet to a second destination digital wallet may become too complex and computationally costly.

Implementations of the conversion engine may perform one or more of the following functions. The conversion engine may automatically transfer the amount of currency received from the source digital wallet to a holding account. The conversion engine may locate the currency via communication with a financial institution holding funds associated with the source digital wallet. The conversion engine may locate the currency via communication with a distributed ledger that maintains a record of funds associated with the source digital wallet.

The conversion engine may create packaging for the currency and/or associated sub-amounts while the currency is being held in the holding account. The packaging may prevent a sub-amount from being divided into small amounts. The packaging may allow transfers of each of the sub-amounts to be independently traceable. Illustrative packaging may include encapsulating currency (e.g., a sub-amount) within a secure data structure. The secure data structure may prevent any subdivision of the encapsulated currency. The secure data structure may allow for tracing subsequent transfers of the encapsulated currency.

The secure data structure may include at least a header and a body. The header may include proprietary technology, communication protocols, data structures and encryption associated with a digital wallet system. Currency information, such as an amount of the currency, denomination of the currency unique identifier associated with the currency (e.g., serial number), address on a distributed ledger storing an amount of cryptocurrency or bank account information may be stored in the body.

The conversion engine may change the header information to facilitate processing of the encapsulated currency by proprietary ecosystem of a target digital wallet system and digital wallets associated with that target digital wallet system. Each time the conversion engine changes the header information, the conversion engine may record the change in a distributed ledger or other secure database. Recording each change to the header information may allow the conversion engine to trace movement of the currency described in the body of the secure data structure.

In some embodiments, the conversion engine may package each sub-amount within a specialized data structure corresponding to a non-fungible token (“NFT”) . Each NFT is unique and is not divisible. An NFTs can represent a sub-amount and manage transferability of the sub-amount. An NFT can be created and controlled by a smart contract. When an NFT is generated, code stored in smart contracts is executed that ensures the NFT conform to target standard for enforcing one or more properties of the NFT.

An NFT may be generated via a smart contract that assigns ownership and manages transferability of the NFT. For instance, a smart contract can create and NFT and define rights associated with the NFT. Such rights may include preventing or authorizing execution of transactions and validating the entire transaction history of a sub-amount represented by the NFT.

An illustrative target standard for creating an NFT includes the ERC-521 or ERC-1155 standards for creating, storing and transferring NFTs on the Ethereum distributed ledger. NFT generation using the ERC-521 or ERC-1155 standards includes creating a new data record that includes information that will represent the NFT. Illustrative information may be a unique identifier, a type of currency (e.g., USD, EUR, AUD, GBP, JPY, CAD), an amount of the currency type and a digital wallet that owns the NFT. Other distributed ledgers that include standards for enforcing NFT protocols include the FLOW blockchain, the TEZOS blockchain, and the SOLANA blockchain.

After initial creation of an NFT as a new data record, the NFT is validated by other nodes on a distributed ledger (e.g., the Ethereum distributed ledger). Such validation may include executing a consensus algorithm such as such as Proof of Work, Proof of Stake or Practical Byzantine Fault Tolerance. After the consensus algorithm confirms authenticity of the NFT, the NFT (e.g., the data record) may be recorded into the distributed ledger.

By definition, an NFT is digitally unique and no two NFTs are identical. Also, the identity of the creator of an NFT becomes a permanent part of the NFT’s history. The unique identify of a creator can demonstrate original ownership of currency corresponding to the NFT. Thus, each sub-amount may be represented on a distributed ledger as a traceable NFT. An NFT is also not divisible. Therefore, representing a sub-amount as an NFT may prevent further subdivision of the sub-amount. An NFT may be stored on a distributed ledger and the information in the NFT is therefore easily traceable and verifiable.

In some embodiment, the computer executable instructions that package each of the sub-amounts may allow each sub-amount to be further subdivided. For example, a sub-amount may be subdivided after expiration of a threshold amount of time following a transfer from a source digital wallet to a destination digital wallet. For example, the smart contract that defines an NFT may allow the currency described in the NFT to be subdivisible only after a threshold amount of time following a transfer of the currency represented by the NFT. The threshold amount of time may provide a time window for an original owner of the currency to trigger a fraud alert associated with the currency described in the NFT.

For example, a customer may be fraudulently induced to transfer currency. An unscrupulous actor may masquerade as a relative of the customer in dire need of emergency funds. The customer may initiate a transfer of currency thinking they are helping their relative. After the customer initiates the transfer, the customer may become aware of the fraud. For example, the customer may eventually contact their relative via other communication channels or meet the relative in person and realize the relative had never requested or needed the currency. After becoming aware that the transfer of currency was fraudulently induced, the customer may trigger a fraud alert.

The fraud alert may be triggered using the source digital wallet originally used to initiate a transfer of the currency to a first destination digital wallet. The fraud alert may include a request to recover the fraudulently transferred currency. The recovery request may be or include a clawback instruction. The clawback instruction request return to the customer of any currency that has been erroneously transferred by the customer to the destination digital wallet. The conversion engine may include computer executable instructions that receive the clawback instruction from the customer. The clawback instructions may by authorized by the source digital wallet.

In response to receiving the clawback instruction, the conversion engine may locate each of the sub-amounts associated with a transfer of currency. For example, if each of the sub-amounts have been represented as NFTs, the conversion engine may locate a current location of each NFT on the distributed ledger storing the NFTs. The conversion engine may trigger execution of the smart contract that controls transferability of each of the NFTs.

In response to being notified of a clawback request, the smart contracts may lock each of NFTs corresponding to the sub-amounts. Locking the NFT may prevent each sub-amount from being transferred from a digital wallet that currently owns the NFT to any other digital wallet.

The smart contract associated with a NFT or packaged sub-amount may include computer executable instructions that detect a transfer of at least one sub-amount to a target destination digital wallet. The target digital wallet may be associated with a known unscrupulous actor. For example, the target digital wallet may be associated with multiple fraud alerts or clawback requests. In response to detecting a transfer to the target destination digital wallet, the conversion engine may automatically trigger a transfer of at least one of the sub-amounts back to the source digital wallet or any other remedial action.

A conversion engine for bridging between multiple, incompatible digital wallet systems is provided. Implementations of the conversion engine may include hardware, a method or process, or computer software embodied on a non-transitory computer-accessible medium. For example, the conversion engine may include a processor and non-transitory memory storing computer executable instructions. The computer executable instructions, when executed by the processor, may perform a method for tracing a transfer of electronic currency.

The method may include receiving a request from a source digital wallet to transfer electronic currency to a destination digital wallet. Based on a value of the electronic currency and the destination digital wallet, the method may include determining a number of sub-amounts for the electronic currency. The sub-amounts may represent the smallest traceable quantum of electronic currency for the received transfer request.

A size or value of each of the sub-amounts may be determined based on a prior transaction history for the customer that submitted the request. The sub-amount may be determined based on a total number of sub-amounts that may be created for a given value of currency. For example, the prior transaction history for the customer may indicate that the customer typically transfers currency valued between 10-150 USD. In response to receiving a transfer request of 150 USD from the customer, the conversion engine assign a sub-amount value of 50 USD.

The sub-amount may be determined based one or more transaction attributes included in the request. For example, the request may indicate that the transfer is to help a relative with a monthly mortgage payment. Because mortgage payments are typically a fixed payment or at least a single lump payment each month, the entire amount of currency may be classified as a single indivisible sub-amount. Any attempts to subdivide the amount of currency may indicate that the recipient is not using the currency for the purpose described in the request. Some embodiments may allow the customer to assign a sub-amount to a currency transfer before the digital wallet system implements the desired transfer.

When the number of sub-amounts for a desired currency transfer is two or more, the method may include dividing the currency into a number of sub-amounts. The dividing may include encapsulating each of sub-amount in a digital wrapper. The method may include embedding a cryptographic public key in the digital wrapper of each sub-amount. The dividing may include generating an NFT representing each sub-amount. The method may include embedding a cryptographic public key in each NFT

Methods may include detecting a fraud alerts associated with a transfer of electronic currency. The fraud alert may be submitting by the customer that initiated the transfer. The fraud alert may be detected automatically based on a transfer pattern or destination associated with a requested currency transfer. The fraud alert may be generated by a smart contract running on a distributed ledger.

The fraud alert may be detected by a smart contract running on a distributed ledger. For example, the fraud alert may be stored on a distributed ledger, or a known storage location pre-programmed in the smart contract. The smart contract, in response to detecting the fraud alert may trigger execution of an automated quarantine routine. The automated quarantine routine may issue instructions to one or more digital wallet systems.

In response to detecting a fraud alert associated with the electronic currency, the method may include initiating an automated quarantine routine. The automated quarantine routine may issue instructions to a smart contract embedded in one or more of the sub-amounts. The automated quarantine routine may issue instructions to the smart contract that prevents each of the sub-amounts from being transferred without prior authorization. The prior authorization may be a transfer instruction signed using a cryptographic private key paired to a cryptographic public key associated with, or embedded in packaging of, the sub-amount.

Digital wallet systems may include multiple, incompatible digital wallet systems. The instructions issued by the automated quarantine routine may be formulated based on proprietary technology, communication protocols, data structures and encryption used by any one of the incompatible digital wallet systems. The instructions issued by the automated quarantine routine prevent each of the sub-amounts from being transferred without prior authorization. The prior authorization may be a transfer instruction signed using a cryptographic private key paired to the cryptographic public key of a sub-amount. The instructions issued by the automated quarantine routine may freeze activity of any digital wallet or conventional bank account that contains any one of the sub-amounts.

In response to detecting a fraud alert, the method may include initiating an automated return procedure of the electronic currency to the source digital wallet. The automated return procedure may include one or more smart contracts that execute on a distributed ledger. The automated return procedure may only be activated in response to detecting the fraud alert in a target location on the distributed ledger within a predetermined time after receiving the original transfer request from a source digital wallet.

The automated return procedure may prevent each of the number of sub-amounts from being further subdivided. In response to detecting a fraud alert after the predetermined time, the automated return procedure may not automatically initiate a return or clawback of the sub-amounts. In response to detecting a fraud alert after the predetermined time, the automated return procedure may continue to trace movement of each of the number of sub-amounts. The tracing may include storing a current location of each of the number of sub-amounts in a secure location on the distributed ledger. The tracing may include recording each transfer of each of the number of sub-amounts.

In response to detecting a fraud alert, a smart contract embedded in a sub-amount may initiate a homing beacon. The homing beacon may broadcast a current location of a sub-amount. The homing beacon may broadcast the current location and the received fraud alert to one or more digital wallet systems. The conversion engine may distribute a detected fraud alert to two or more incompatible digital wallet systems. The broadcast may be transmitted to each of the incompatible digital wallets systems that has received at least one of the sub-amounts.

The broadcast may be transmitted using a gossip communication protocol. A gossip communication protocol may include a procedure or process of computer communication formulated based on the way epidemics spread. Such communication may include peer-to-peer communication without centralized control to ensure that the transactional integrity is received by each of the multiple digital wallet systems. The smart contact associated with each sub-amount may formulate a message for a target digital wallet systems based on proprietary technology, communication protocols, data structures and encryption used by the target digital wallet system.

Apparatus may include an artificial intelligence (“AI”) engine for tracing movement of electronic currency. The AI engine may trace movement of the electronic currency among multiple, incompatible digital wallet systems. Digital wallet systems may be incompatible because each system uses its own proprietary technology, communication protocols, data structures or encryption scheme. The AI engine may include computer executable instructions that, when executed by a processor, implement functional features of the AI engine. Embodiments of the AI engine may include computer systems, apparatus, and computer programs recorded on one or more computer storage devices, each configured to perform the functions coded into the AI engine.

The AI engine may assign a serial number or other unique identifier to electronic currency. Electronic currency may include cryptocurrency or government issued currency. The AI engine may associate the serial number and a cryptographic public key with the electronic currency. For example, the AI engine may embed the serial number and cryptographic public key in smart contract that controls transfer of the electronic currency.

The AI engine may detect a fraud alert associated with the electronic currency. The fraud alert may be submitted by a customer that initiated a transfer of the electronic currency. For example, after the customer electronically transfers the electronic currency, the customer may realize the transfer was fraudulently induced. The customer may submit the fraud alert in an attempt to recover the erroneously transmitted electronic currency.

In response to detecting a fraud alert associated with the electronic currency, the AI engine may initiate an automated quarantine routine. The automated quarantine routine may prevent any further transfer of the electronic currency without authorization from a cryptographic private key paired to the cryptographic public key.

The AI engine may encapsulate a sub-amount of the electronic currency in a digital wrapper. The sub-amount may represent less than a total value of the electronic currency. After detecting the fraud alert, the AI engine may detect an attempt to transfer a sub-amount of the electronic currency. The digital wrapper encapsulating the sub-amount may include a serial number and a cryptographic public key.

A private cryptographic key may be paired to the cryptographic public key. The private cryptographic key may be used to sign messages or instructions. Authenticity of the messages or instructions signed using the private cryptographic key may be verified by the public cryptographic key. The AI engine may receive an authorization to reverse a transfer of the electronic currency.

The fraud alert and authorization may be stored to a distributed ledger. A smart contract associated with the electronic currency (or sub-amount thereof) may detect that the fraud alert or authorization has been stored on the distributed ledger. The smart contract may verify that the fraud alert and authorization have been validly signed by a cryptographic private key. Use of the private cryptographic private key may be regulated by an entity that has accepted responsibility for ensuring legitimacy of transfers associated with the electronic currency.

In response in response to detecting the fraud alert and/or authorization to reverse a transfer, the AI engine may automatically initiate a reverse transfer of the electronic currency. The reverse transfer may be initiated by a smart contract associated with the electronic currency or sub-amount thereof. The smart contract may be included in a digital wrapper that encapsulates the electronic currency or sub-amount thereof.

The reverse transfer may move the sub-amount from a current digital wallet storing a sub-amount of the electronic currency to a target destination digital wallet. The target destination digital wallet may be associated with the entity that has accepted responsibility for ensuring legitimacy of transfers associated with the electronic currency. The target destination digital wallet may be a source digital wallet that initiated a transfer of the electronic currency before the fraud alert. Execution of the reverse transfer may return erroneously transferred electronic currency to a customer.

The AI engine may create an NFT. The NFT may be a digital wrapper that encapsulates the electronic currency or sub-amount thereof. The process of creating an NFT may include executing computer code stored in a smart contracts conform to a standard for creating non-fungible tokens. An illustrative standard may include ERC-721 for creating NFTs on the Ethereum blockchain.

Information (e.g., currency amount, unique identifier, smart contract) associated with the NFT is added to a distributed ledger where the NFT will be managed. An illustrative NFT creation process may include: (1) creating a new record corresponding to the NFT that will be added to a distributed ledger, (2) requesting that nodes maintaining the distributed ledger validate the new record and (3) after receiving consensus from the nodes, recording the information corresponding to the NFT on the distributed ledger.

The NFT may be stored on a distributed ledger in a record that includes the electronic currency, the serial number and the cryptographic public key. The AI engine may track transfers of the NFT on the distributed ledger. The AI engine may track transfers of the NFT from a first distributed ledger to a second distributed ledger. The first and second distributed ledgers may be associated with incompatible digital wallet systems. The AI engine may enable transfers of the NFT from the first distributed ledger associated with a first digital wallet system to the second distributed ledger system associated with a second digital wallet system. The second digital wallet system be incompatible with the first digital wallet system.

An NFT may include instructions (e.g., a smart contract) that suspends tracing of the electronic currency after a predetermined amount of time. The NFT may include instructions that allow the electronic currency to be transferred in subdivided amounts after a predetermined amount of time. The predetermined amount of time may be measured starting from a transfer of the electronic currency from a target source digital wallet. The predetermined amount of time may be measured starting from a transfer of the electronic currency by a target customer. The target source digital wallet may be automatically determined based on history transaction record associated with the source digital wallet.

For example, if the source digital wallet initiates a transfer to a destination digital wallet that is known to be associated with fraudulent activity, the AI engine may automatically encapsulate in a digital wrapper and trace all transfers of electronic currency initiated by the source digital wallet to the destination digital wallet. In some embodiments, the AI engine may automatically encapsulate, in a digital wrapper, any electronic currency transferred by a source digital wallet to a destination digital wallet that has not previously received electronic currency from the source digital wallet.

Apparatus and methods in accordance with this disclosure will now be described in connection with the figures, which form a part hereof. The figures show illustrative features of apparatus and method steps in accordance with the principles of this disclosure. It is to be understood that other embodiments may be utilized, and that structural, functional and procedural modifications may be made without departing from the scope and spirit of the present disclosure.

The steps of methods may be performed in an order other than the order shown and/or described herein. Method embodiments may omit steps shown and/or described in connection with illustrative methods. Method embodiments may include steps that are neither shown nor described in connection with illustrative methods. Illustrative method steps may be combined. For example, an illustrative method may include steps shown in connection with any other illustrative method.

Apparatus may omit features shown and/or described in connection with illustrative apparatus. Apparatus embodiments may include features that are neither shown nor described in connection with illustrative apparatus. Features of illustrative apparatus may be combined. For example, an illustrative apparatus embodiment may include features shown or described in connection with another illustrative apparatus/method embodiment.

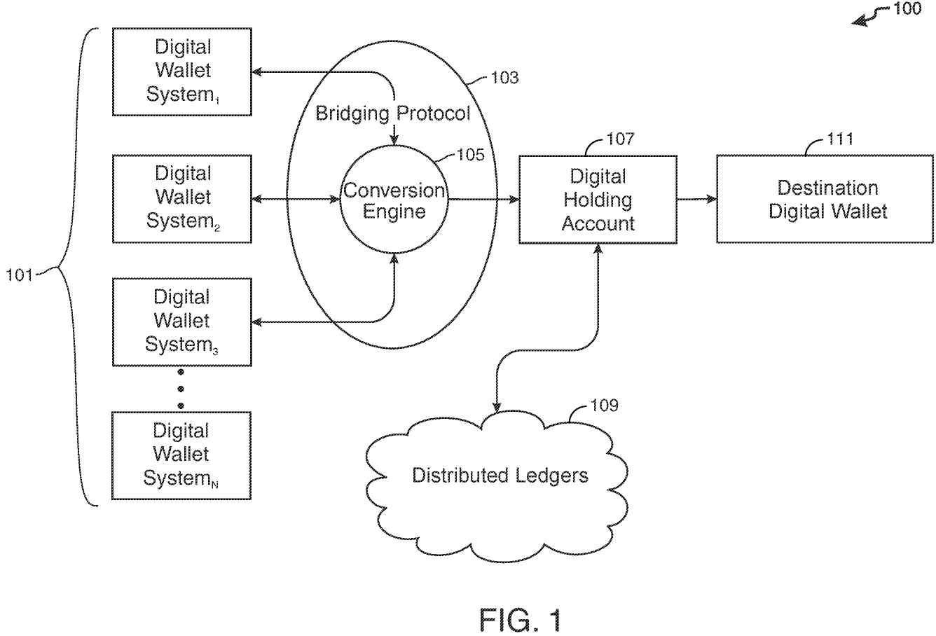

FIG. 1 shows illustrative system 100. System 100 includes digital wallet systems 101. Digital wallet systems 101 may each be incompatible with each other. For example, digital wallet system, may be unable to transfer currency to digital wallet system₂. Digital wallet system₂ may be unable to receive currency from digital wallet system₃.

System 100 includes bridging protocol 103. Bridging protocol 103 may receive transfer requests generated by one or more of digital wallet systems 101. The transfer requests may be received from a digital wallet that interfaces with a particular digital wallet system. A digital wallet may be a digital wallet system component run on a mobile device of a customer of a particular digital wallet system. The digital wallet may include a private cryptographic key that authorizes currency transfers initiated by the customer.

In response to receiving a transfer request from digital wallet systems 101, bridging protocol 103 may utilize conversion engine 105. Conversion engine 105 may convert a transfer request into a format that may be processed by bridging protocol 103. Conversion engine 105 may convert a transfer request received from one of digital wallet systems 101 into a format that may be processed by different one of digital wallet systems 101. In some embodiments, conversion engine 105 may reside entirely within bridging protocol 103.

In some embodiments, conversion engine 103 may include a client-side application that runs on customer’s mobile device. Bridging protocol 103 may include a server-side application of conversion engine 105. The client-side application of conversion engine 105 may intercept a transfer request formulated by a source digital wallet. The client-side application may convert a transfer request into a format usable by bridging protocol 103.

Conversion engine 105 may be configured to forward currency to digital holding account 105. After bridging protocol 103 receives the converted transfer request, a server-side application of conversion engine 105 may generate instructions for transferring currency identified in the transfer request from a source account associated with source digital wallet system to digital holding account 105. After bridging protocol 103 receives the converted transfer request, a server-side application of conversion engine 105 may generate instructions for transferring currency identified in the transfer request from digital holding account 105 to a destination digital wallet associated with a destination digital wallet system.

Digital holding account 105 may hold currency received from one or more of digital wallet systems 101. Currency received by digital holding account 105 may be recorded in on or more of distributed ledgers 109. Distributed ledgers 109 may be associated with one or more of digital wallet systems 101. Destination digital wallet 111 may be controlled by one or more digital wallet systems 101. Funds transferred into digital holding account 105 may be assigned a unique identifier by conversion engine 105. In some scenarios, funds received by bridging protocol 103 may already be associated with a unique identifier previously assigned by conversion engine 105.

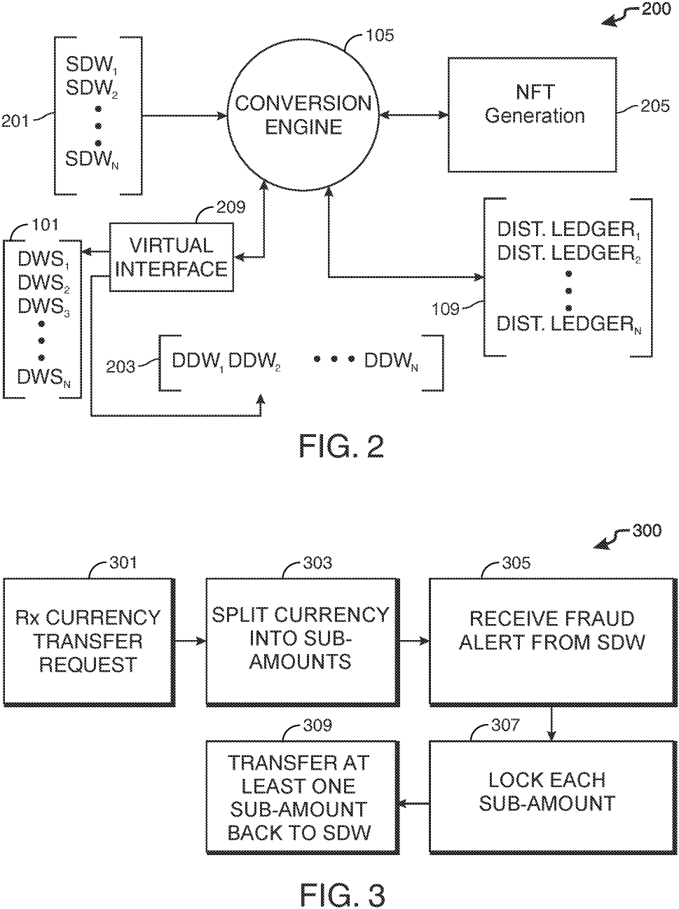

FIG. 2 shows illustrative system 200. System 200 includes source digital wallets (“SDW”) 201. Each of SDW 201 may include an end-user application (e.g., software and/or hardware) for interfacing with at least one of digital wallet systems 101. A user of SDW 201 may submit a request for transferring currency to one or more of destination digital wallet (“DDW”) 203. Each of DDW 203 may be end-user application for interfacing with at least one of digital wallet systems 101.

The currency transfer request submitted by SDW 201 may be intercepted by conversion engine 105 (shown in FIG. 1). In response to intercepting a transfer request from SDW 201, conversion engine 105 may extract from the request a first destination digital wallet and an amount of electronic currency stored within the source digital wallet. Conversion engine 105 may divide the extracted amount of electronic currency into a plurality of sub-amounts. Conversion engine 105 may assign a unique identifier to each sub-amount. Conversion engine 105 may package each sub-amount in a digital wrapper such that each sub-amount cannot be subdivided in any subsequent transfers from the first destination digital wallet to a second destination digital wallet.

For example, conversion engine 105 may provide NFT generation service 205. NFT generation service 205 may create an NFT for two or more sub-amounts of an amount of transferred electronic currency. NFT generation service 205 may store each created NFT in one or more of distributed ledgers 109 (also shown in FIG. 1). One or more of distributed ledgers 109 may include records of transactions processed by conversion engine 105. One or more of distributed ledgers 109 may include records maintained by one or more of digital wallet systems 101.

Conversion engine 105 may correlate records stored in distributed ledgers 109 with transfer requests received from SDW 201 or DDW 203. The correlating may be performed based on unique identifiers associated with one or more NFTs created by conversion engine 105.

System 200 also includes virtual interface 209. Virtual interface 209 may be generated by conversion engine 105. Conversion engine 105 may generate virtual interface 209 to access a digital wallet system 101. In some embodiments conversion engine 105 may generate one or more of virtual interfaces 209 to communicate with one or more DDW 203. Conversion engine 105 may generate a virtual interface 209 based on information received from SDW 201. Virtual interface 209 may bridge incompatibility between SDW 201 and DDW 203. Conversion engine 105 may transfer currency from SDW 201 to DDW 203 via virtual interface 209. Virtual interface 209 may formulate instructions for a one of SDW 201 or DDW 203 based on proprietary technology, communication protocols, data structures and encryption used by any one of SDW 201 or DDW.

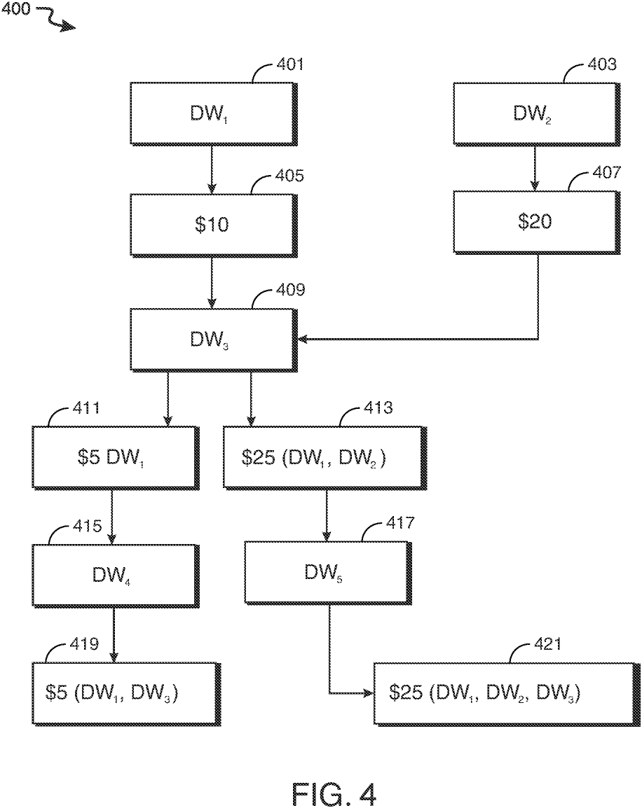

FIG. 3 shows illustrative process 300. One or more of the steps of the process illustrated in FIG. 3 may be performed by a “system.” The “system” may include one or more of the features of the apparatus shown in FIGS. 1-2 and/or any other suitable device or approach. The “system” may be provided by an entity. The entity may have accepted responsibility for ensuring legitimacy of transfers associated with the electronic currency. The entity may be an individual, an organization or any other suitable entity.

Process 300 begins at step 301. At step 301 the system receives a currency transfer request. The request may be received from a source digital wallet (e.g., SDW 201) asking to transfer an amount of currency to a destination digital wallet (e.g., DDW 203). At step 303, before transferring the currency to the destination digital wallet, the system splits currency in a number of traceable sub-amounts.

For example, a source digital wallet may request that an amount of currency be transferred to a destination digital wallet. The requested amount of currency may be split into a number of sub-amounts. Each sub-amount of currency may be assigned a unique identifier enabling conversion engine 105 to trace any subsequent transfers of each sub-amount.

At step 305, the system receives a fraud alert from the source digital wallet. The fraud alert may allege that the transfer request received at step 301 was fraudulently induced. At step 305, in response to the fraud alert, the system locks each sub-amount. Locking each sub-amount may include preventing any destination digital wallet that received any of the sub-amounts from initiating any further transfers of the sub-amount.

Step 305 may include validating the fraud alert received at step 305. Such validating may include mapping a flow of the sub-amounts based on the tracing. Such validating may include mapping a flow of traceable currency into and out of one or more digital wallets (e.g., DDW 203) that received one or more sub-amounts. Validating the transactional integrity may include confirming that security of a source digital wallet associated with the currency has not been compromised. Validating the transactional integrity may include determining that security of a destination digital wallet has not been compromised.

At step 309, the system transfers at least one sub-amount back to the source digital wallet. The source digital wallet may be associated with a source digital wallet system. The destination digital wallet may be associated with a destination digital wallet system. The source digital wallet system may be incompatible with the destination digital wallet system. The transfer back to the source digital wallet may include formulating communications that are operable with the digital wallet system of the destination digital wallet identified in the transfer request received at step 301.

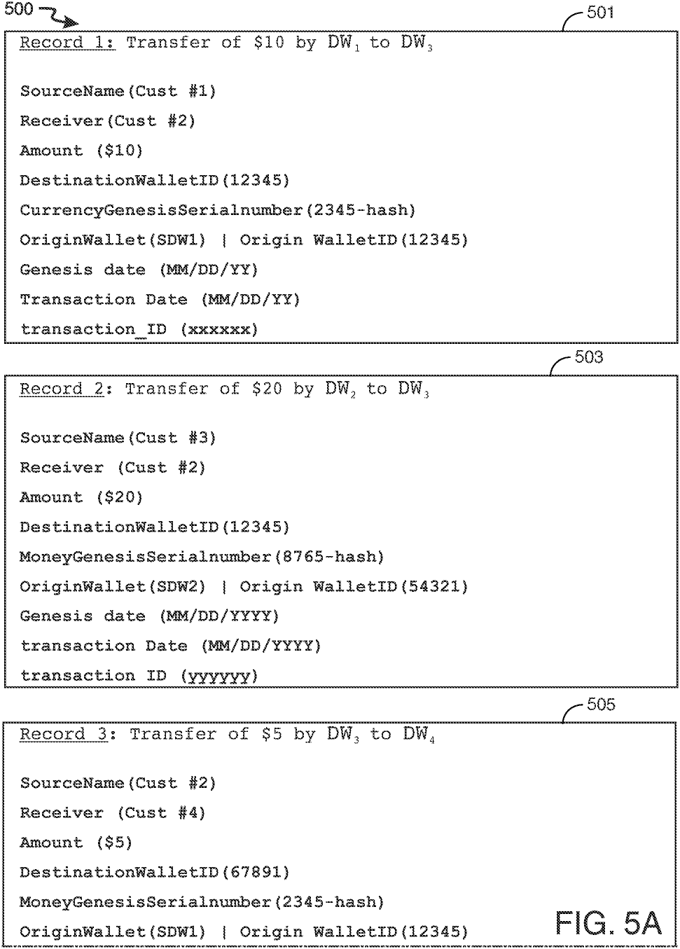

FIG. 4 shows illustrative tracing 400 of currency transfers. Conversion engine 105 may implement tracing 400 of currency. Movement 400 shows that digital wallet₁ (“DW₁”) 401 initiates a transfer of sub-amount 405 ($10) to digital wallet 409 (DW₃). Sub-amount 405 may be associated with a first unique identifier. Tracing 400 also shows that at step 403, DW₂ initiates a transfer of sub-amount 405 ($20) to digital wallet 409 (DW₃). Sub-amount 405 ($20) may be associated with a second unique identifier.

At step 409, after transfers of sub-amounts 405 and 405, DW₃ is associated with a total balance of $30. The total balance of $30 may be associated with two unique identifiers associated with sub-amounts 405 and 405. At step 411, DW₃ requests a transfer of $5 to digital wallet 415 (DW₄). Step 411 also shows that the $5 selected for transfer to DW₄ is a sub-amount of currency DW₃ received from DW₁. The $5 selected for transfer to DW₄ may be recorded on one or more of distributed ledgers 109 (shown in FIG. 1) as being associated with the unique identifier of sub-amount 405. At step 413, DW₃ requests a transfer of $25 to digital wallet 415 (DW₅). Step 413 also shows that the $25 selected for transfer to DW₅ includes sub-amounts received from DW₁ and DW₂. The $25 selected for transfer to DW₅ may be associated with the unique identifiers of both sub-amounts 405 and 407.

Step 421 shows that after DW₅ receives the $25 from DW₃, the $25 is associated with unique identifiers that trace the origin of the sub-amounts back to DW₁, DW₂ and DW₃. Step 419 shows that after DW₄ receives the $5 from DW₃, the $5 is associated with unique identifiers that trace the origin of the currency back to DW₁ via DW₃ .

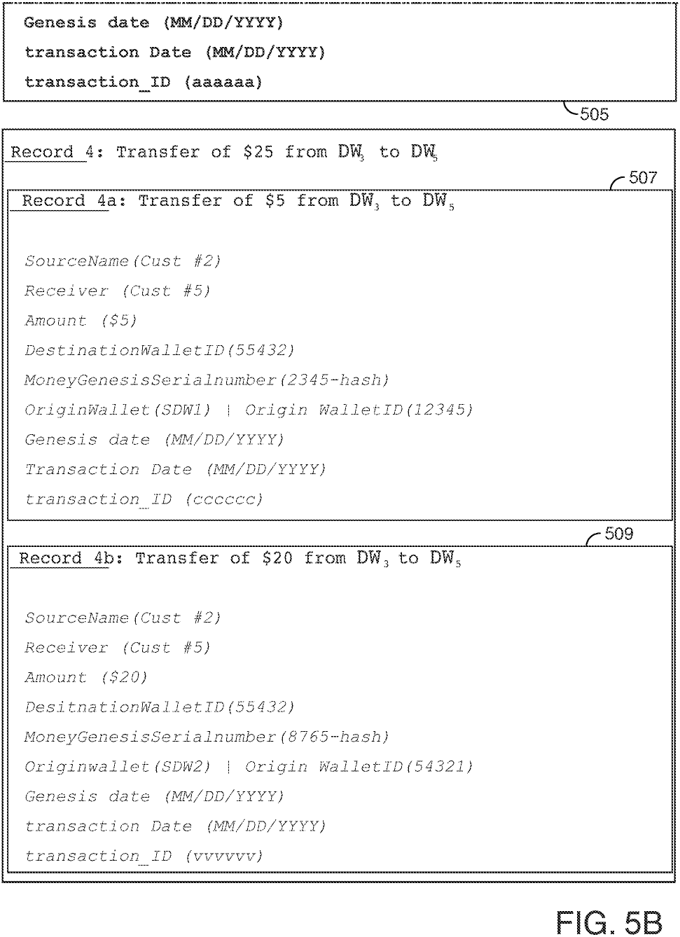

FIGS. 5A and 5B show illustrative transaction records that may be generated by tracing 400 shown in FIG. 4. The transaction records may be stored in a distributed leger such as distributed ledgers 109. Records shown in FIGS. 5A and 5B may be stored as a NFT on distributed ledgers 109. Record 501 includes attributes evidencing the transfer of $10 from DW₁ to DW₃. Record 501 shows that the $10 transferred from DW₁ to DW₃ is associated with unique identifier (“MoneyGenesisSerialnumber”) (2345-hash).

Record 503 includes attributes evidencing the transfer of $20 from DW₂ to DW₃. Record 503 shows that the $20 transferred from DW₂ to DW₃ is associated with the unique identifier (8565-hash) .

Record 505 includes attributes evidencing the transfer of $5 from DW₃ to DW₄. Record 505 shows that the $5 transferred from DW₃ to DW₄ is associated with the unique identifier (2345-hash), the same unique identifier included in record 501.

Records 505 and 509 include attributes evidencing the transfer of $25 from DW₃ to DW₅. Record 507 shows that $5 transferred from DW₃ to DW₅ is associated with the unique identifier (2345-hash). Record 509 shows that $20 transferred from DW₃ to DW₅ is associated with the unique identifier (8565-hash).

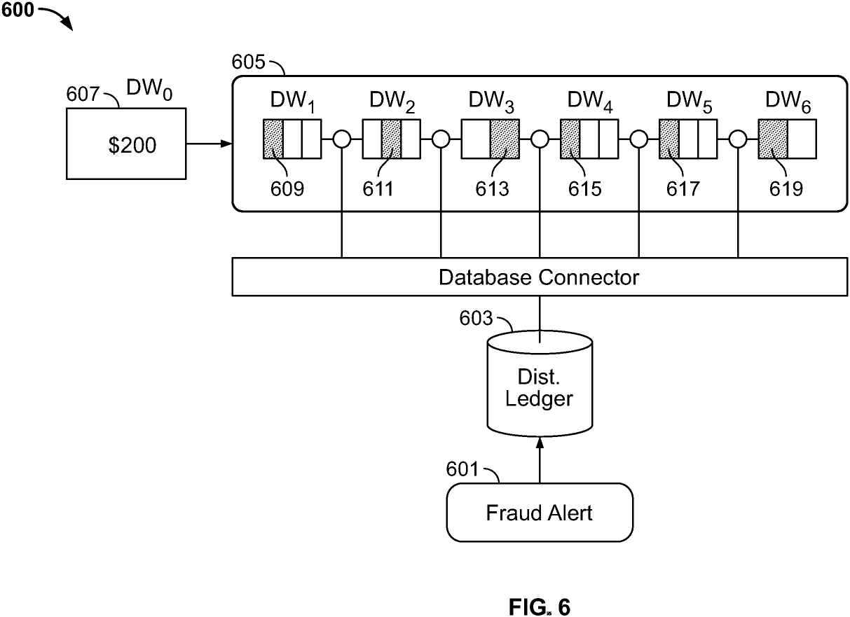

FIG. 6 shows illustrative tracing 600 of currency transfers. Conversion engine 105 may implement tracing 600 of currency. Tracing 600 shows that an initial transfer request 607 from a source digital wallet (DW₀) included a total transfer amount of $200. In response to receiving request 607, the total transfer amount has been assigned eight sub-amounts of $25 each. Each sub-amount of $25 may be encapsulated in a digital wrapper. The digital wrapper may include a smart contract that traces movement of a sub-amount on distributed ledger 603. Distributed ledger 603 may included in distributed ledgers 109 (shown in FIG. 1).

Tracing 600 shows that destination digital wallets 609 (DW₁), 611 (DW₂), 615 (DW₄) and 617 (DW₅) currently each hold a sub-amount of $25. Tracing 600 shows that digital wallets 613 (DW₃) and 619 (DW₆) currently each hold two sub-amounts of $25 or a total of $50 each. In response to receiving fraud alert 601, smart contracts associated with each of the sub-amounts stored in DW₁₋₆ may quarantine each of the sub-amounts stored therein. Smart contract associated with each sub-amount may initiate an automated quarantine routine that prevents each sub-amount from being transferred without authorization from a cryptographic private key. The smart contract associated with each sub-amount may initiate an automated return of all the electronic currency ($200) to source DW₀.

Thus, apparatus and methods for a DIGITAL WALLET TRACING ENGINE are provided. Persons skilled in the art will appreciate that the present disclosure can be practiced by other than the described embodiments, which are presented for purposes of illustration rather than of limitation. The present disclosure is limited only by the claims that follow.

What is claimed is:

1. A conversion engine for bridging among multiple, incompatible digital wallet systems, the conversion engine comprising a processor and non-transitory memory storing computer executable instructions that, when executed by the processor:
receive a request from a source digital wallet;
extract from the request a first destination digital wallet and an amount stored within the source digital wallet;
based on the amount and the first destination digital wallet, divide the amount into a plurality of sub-amounts;
assign a unique identifier to each sub-amount; and
package each sub-amount such that each sub-amount cannot be subdivided in any subsequent transfers from the first destination digital wallet to a second destination digital wallet.

2. The conversion engine of claim 1, wherein the computer executable instructions automatically transfer the amount from the source digital wallet to a holding account.

3. The conversion engine of claim 2, wherein the computer executable instructions:
automatically extract the amount from the holding account;
package each sub-amount by creating a non-fungible token (“NFT”) corresponding to each sub-amount; and
storing the NFT on a distributed ledger.

4. The conversion engine of claim 1, wherein the computer executable instructions that package each of the sub-amounts encapsulate each of the sub-amounts in a digital wrapper that prevents each sub-amount from being subdivided by any of the multiple, incompatible digital wallet systems.

5. The conversion engine of claim 1, further comprising computer executable instructions that:
receive a clawback instruction from the source digital wallet;
in response to the clawback instruction, locate each of the sub-amounts; and
lock each of the sub-amounts such that each sub-amount cannot be transferred from a current digital wallet holding any of the sub-amounts.

6. The conversion engine of claim 4 wherein the computer executable instructions that package each of the sub-amounts allow each of the sub-amount to be subdivided a threshold amount of time after being transferred out of the source digital wallet.

7. The conversion engine of claim 1 wherein the computer executable instructions that package each sub-amount:
encapsulate each sub-amount in a digital wrapper; and
embeds a smart contract into the digital wrapper.

8. The conversion engine of claim 7 wherein the smart contract comprises computer executable instructions that:
detect a transfer of at least one of the sub-amounts to a target destination digital wallet; and
in response to detecting the transfer to the target destination digital wallet, transfers the at least one of the sub-amounts from a current digital wallet back to the source digital wallet.

9. A computer executable method for tracing transfers of electronic currency, the method comprising extracting computer readable instructions stored on a non-transitory medium and executing the computer readable instructions on a processor, wherein execution of the computer readable instructions by the processor:
receives a request from a source digital wallet to transfer the electronic currency to a destination digital wallet;
based on a value of the electronic currency and the destination digital wallet, determines a number of sub-amounts for the electronic currency;
divides the electronic currency into the number of sub-amounts;
embeds a cryptographic public key in each sub-amount; and
in response to detecting a fraud alert associated with the electronic currency, initiates an automated quarantine routine that prevents each sub-amount from being transferred without authorization from a cryptographic private key paired to the cryptographic public key.

10. The method of claim 9 wherein execution of the computer readable instructions by the processor freezes transfer activity of any account that contains any one of the number of sub-amounts.

11. The method of claim 9 wherein execution of the computer readable instructions by the processor embeds a smart contract into each of the number of sub-amounts, wherein the smart contract activates the automated quarantine routine in response to detecting the fraud alert in a target location on a distributed ledger within predetermined time after receiving the request.

12. The method of claim 11 wherein the smart contract prevents each of the number of sub-amounts from being further subdivided.

13. The method of claim 12 wherein in response to detecting the fraud alert after the predetermined time, the smart contract stores a current location of each of the number of sub-amounts in a secure location on the distributed ledger.

14. The method of claim 12 wherein each sub-amount is determined based on a value of the electronic currency.

15. The method of claim 11 wherein the smart contract in response to detecting the fraud alert, initiates an automated return of the electronic currency to the source digital wallet.

16. The method of claim 11 wherein the smart contract in response to detecting the fraud alert, initiates a homing beacon that broadcasts a current location of each of the number of sub-amounts.

17. An artificial intelligence (“AI”) engine for tracing movement of electronic currency among multiple, incompatible digital wallet systems, the AI engine comprising a processor and non-transitory memory storing computer executable instructions that, when executed by the processor:
assigning a serial number to the electronic currency;
embed the serial number and a cryptographic public key in the electronic currency; and
in response to detecting a fraud alert associated with the electronic currency, initiates an automated quarantine routine that prevents the electronic currency from being transferred without authorization from a cryptographic private key paired to the cryptographic public key.

18. The AI engine of claim 17, further comprising computer executable instructions that, when executed by the processor, in response to an attempt to transfer a sub-amount of the electronic currency, embed the serial number and the cryptographic public key in the sub-amount.

19. The AI engine of claim 17 further comprising computer executable instructions that, when executed by the processor, in response to detecting authorization from the cryptographic private key paired to the cryptographic public key, automatically initiating a reverse transfer of the electronic currency from a current location of the electronic currency to a target destination.

20. The AI engine of claim 17 further comprising computer executable instructions that, when executed by the processor, create a non-fungible token (“NFT”) stored on a distributed ledger, wherein the NFT includes the electronic currency, the serial number and the cryptographic public key.
